(19) United States
(12) Patent Application Publication
(10) Pub. No.: US 2024/0135147 A1
(43) Pub. Date: Apr. 25, 2024

(54) METHOD AND APPARATUS WITH TRANSFORMER MODEL TRAINING

(71) Applicants: SAMSUNG ELECTRONICS CO., LTD., Suwon-si (KR); Seoul National University R&DB Foundation, Seoul (KR)

(72) Inventors: Jung Ho AHN, Seoul (KR); Sun Jung LEE, Seoul (KR); Jae Wan CHOI, Seoul (KR)

(73) Assignees: SAMSUNG ELECTRONICS CO., LTD., Suwon-si (KR); Seoul National University R&DB Foundation, Seoul (KR)

(21) Appl. No.: 18/450,839

(22) Filed: Aug. 15, 2023

(30) Foreign Application Priority Data
Oct. 18, 2022 (KR) 10-2022-0135259

(51) Int. Cl. G06N 3/0455

(52) U.S. Cl. CPC G06N 3/0455

(57) ABSTRACT

A device including processors configured to execute instructions and memories storing the instructions, which when executed by the processors configure the processors to perform an operation for training a transformer model having a plurality of encoders and a plurality of decoders by configuring the processors to identify the batches of training data into a plurality of micro-batches, select layer pairs for the plurality of micro-batches, assemble a processing order of the layer pairs, determining resource information to be allocated to the layer pairs, and allocate resources to the layer pairs based on the determined resource information to be allocated to the layer pairs, dependent con the processing order of the layer pairs.

### CROSS-REFERENCE TO RELATED APPLICATIONS

This application claims the benefit under 35 USC § 119(a) of Korean Patent Application No. 10-2022-0135259, filed on Oct. 19, 2022, at the Korean Intellectual Property Office, the entire disclosure of which is incorporated herein by reference for all purposes.

### BACKGROUND

### 1. Field

The following description relates to a method and device with transformer model training.

### 2. Description of Related Art

A transformer model may be a model that is implemented with attention or self-attention while following an encoder-decoder structure, such as an existing seq2seq structure. Although a typical transformer model uses the encoder-decoder structure and does not use a recurrent neural network (RNN), the performance of the typical model may generally be greater than that of the RNN. Typical transformer models may be used to perform tasks such as natural language processing (NLP), translation, questioning and answering (Q&A), and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a device, including one or more processors configured to execute instructions and a plurality of memories storing the instructions, which when executed by the processors configure the processors to perform an operation for training a transformer model having a plurality of encoders and a plurality of decoders, by configuring the processors to identify batches of training data into a plurality of micro-batches, select layer pairs for the plurality of micro-batches, assemble a processing order of the layer pairs, determine resource information to be allocated to the layer pairs, and allocating resources to the layer pairs based on the determined resource information to be allocated to the layer pairs, dependent on the processing order of the layer pairs.

The one or more processors may be configured to divide the batches into a plurality of micro-batches having no dependency on each other.

The one or more processors may be configured to calculate an idle time in response to resources being allocated to the layer pairs.

The one or more processors may be configured to calculate the idle time until the calculated idle time is minimized for the layer pairs.

For the selecting, the one or more processors may be configured to assign layers of the plurality of micro-batches as the layer pairs based on an idle time.

The one or more processors may be configured to calculate a total operation execution time in response to resources being allocated to the layer pairs.

For the selecting, the one or more processors may be configured to minimize the total operation execution time, used in the identifying, until the calculated total operation execution time is minimized.

For the identifying, the one or more processors may be configured to assign layers of the plurality of micro-batches as the layer pairs based on a total operation execution time.

The one or more processors may be configured to determine the resource information through the processors being configured to respectively classify layers of each of the layer pairs into a corresponding layer type, among predefined layer types, according to an operation per byte ratio of an operation performed on each of the layers and determine resource information to be allocated to the layer types where each layer belongs to a separate type of layer.

The predefined layer types may include a first layer type including layers having a first operation per byte ratio of the operation performed on each of the layers that is greater than or equal to a predetermined first reference operation per byte ratio, a second layer type including layers having a second operation per byte ratio of the operation performed on each of the layers that is less than the predetermined first reference operation per byte ratio and that is greater than or equal to a predetermined second reference operation per byte ratio, and a third layer type including layers having a third operation per byte ratio of the operation performed on each of the layers that is less than the predetermined second reference operation per byte ratio.

For the determining of resource information, the one or more processors are configured to allocate respective layers that form a respective layer pair to a resource core responsive to the respective layers belonging to a first layer type and a second layer type and allocate a first layer type of the respective layer pair to the resource core and a third layer type of the respective layer pair to a unified vector unit (VU) responsive to the respective layers belonging to the first layer type and the third layer type.

The first layer type may include a layer on which a general matrix multiply operation is performed, the second layer type may include a layer on which a batched general matrix multiply operation is performed, and the third layer type may include a layer on which a normalization operation is performed.

In a general aspect, here is provided a processor-implemented method including dividing batches of data into a plurality of micro-batches, forming layer pairs from layers of the plurality of micro-batches, generating an operation processing order of the layer pairs, determining resource information to be allocated to the layer pairs, and allocating resources to the layer pairs based on the resource information.

The dividing of the batches into the plurality of micro-batches may include dividing the batches into the plurality of micro-batches to minimize a total operation execution time.

The forming of the layer pairs may include assigning layers from the plurality of micro-batches into the layer pairs to minimize an idle time.

The determining of the resource information to be allocated to the layer pairs may include classifying the layers into predefined layer types according to an operation per byte ratio of each of the layers and determining resource information to be allocated to a respective layer pair comprising layers, of which each layer of the layers belongs to a separate type of the predefined layer types.

The predefined layer types may include a first layer type including layers having a first operation per byte ratio of the operation performed on each of the layers that is greater than or equal to a predetermined first reference operation per byte ratio, a second layer type including layers having a second operation per byte ratio of the operation performed on each of the layers that is less than the predetermined first reference operation per byte ratio and that is greater than or equal to a predetermined second reference operation per byte ratio, and a third layer type including layers having a third operation per byte of an operation performed on each layer that is less than the predetermined second reference operation per byte.

The determining of the resource information may include allocating respective layers that form a respective layer pair to a resource core responsive to the respective layers belonging to a first layer type and a second layer type and allocating a first layer type of the respective layer pair to the resource core and a third layer type of the respective layer pair to a unified vector unit (VU) responsive to the respective layers belonging to the first layer type and the third layer type.

The first layer type may include a layer on which a general matrix multiply operation is performed, the second layer type may include a layer on which a batched general matrix multiply operation is performed, and the third layer type may include a layer on which a normalization operation is performed.

The method may include performing training of a transformer or an inference operation of a trained transformer, using the allocated resources.

In another general aspect, here is provided a non-transitory computer-readable storage medium storing instructions that, when executed by a processor, cause the processor to perform the method.

In a general aspect, here is provided a device including a processor configured to execute instructions and a memory storing the instructions, wherein execution of the instructions configures the processor to be configured to identify a plurality of batches of input data into a plurality of micro-batches, wherein each micro-batch of the plurality of micro-batches has no dependency to other micro-batches of the plurality of micro-batches and assign a layer pair to each micro-batch of the plurality of micro-batch according to a resource consumption indicator, dependent on an analysis of layers of micro-batches for the consumption indicator, and a layer type of each layer of the layer pair.

The processor may be configured to allocate resources to the layer pair based on the resource information to be allocated to a plurality of layer pairs, dependent on a processing order of the layer pairs.

Other features and aspects will be apparent from the following detailed description, the drawings, and the claims.

### BRIEF DESCRIPTION OF THE DRAWINGS

FIG. 1 illustrates an example of an electronic device for scheduling training of a transformer model according to one or more embodiments.

FIG. 2 illustrates an example of scheduling training of a transformer model according to one or more embodiments.

FIG. 3 illustrates an example of scheduling training of a transformer model according to one or more embodiments.

FIGS. 4A and 4B illustrate examples of a resource allocation scheme according to one or more embodiments.

FIGS. 5A and 5B illustrate examples of a resource allocation scheme according to an operation per byte ratio according to one or more embodiments.

FIG. 6 illustrates an example of a control method of an electronic device according to one or more embodiments.

Throughout the drawings and the detailed description, unless otherwise described or provided, it shall be understood that the same drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Examples described herein may be implemented as processing hardware or a combination of processing hardware and instructions stored in a memory also represented by the underling device, where execution of the instructions configures the processing hardware to perform the herein described operations of the corresponding underlying device, or of one or more operations of one or more of the underlying devices described herein. Such processing hardware or combination of processing hardware and instructions may optimize a softmax operation of a transformer model. Examples include a graphics processing unit (GPU) or an accelerator for machine learning as non-limiting examples. Examples may include in a data center or a cloud environment that includes a server to provide services, such as natural language processing (NLP), translation, and questioning and answering (Q&A), or a mobile system or an embedded system as non-limiting examples. Any transformer-based network model may correspond to the transformer models described herein. Hereinafter, examples are described with focus on an inference process using a transformer model (i.e., of a trained transformer model). However, the examples may also include a transformer training process that trains the transformer model.

In an example, transformer models may be used in fields such as image processing, genome analysis, and in NLP. In an example, accelerators may be introduced to improve data center operation efficiency.

One or more examples may improve the efficiency of training transformer models. Typical methods to improve training efficiencies have not been previously utilized due to features of included operations and dependency between the operations. For example, typical transformer model training includes various different operations having different operation per byte ratios corresponding to arithmetic intensity that indicate how many times a piece of data, which is read from an off-chip memory when an accelerator sequentially processes operations, may be reused.

As discussed above, previous methods may not fully utilize computing resources or off-chip memory bandwidth, e.g., according to an operation per byte ratio of an operation. As a non-limiting example, during training of a bidirectional encoder representations from an existing transformer (BERT) model, which is a representative model of NLP tasks, computing resources are underutilized when an operation per byte ratio was low, and memory bandwidth is underutilized when the operation per byte ratio was high.

Herein, one or more examples of scheduling training for a transformer model may mitigate the above-mentioned issues by applying a load balancing technique when training a single large transformer model. In one or more examples, the underlying electronic device may be any of a server-bound accelerator system where resource utilization may be important, an accelerator system that performs a process of training other transformer-based network models, and an accelerator system that uses a network model that alternates between operations having different operation per byte ratios, noting that other examples exist with other devices and systems.

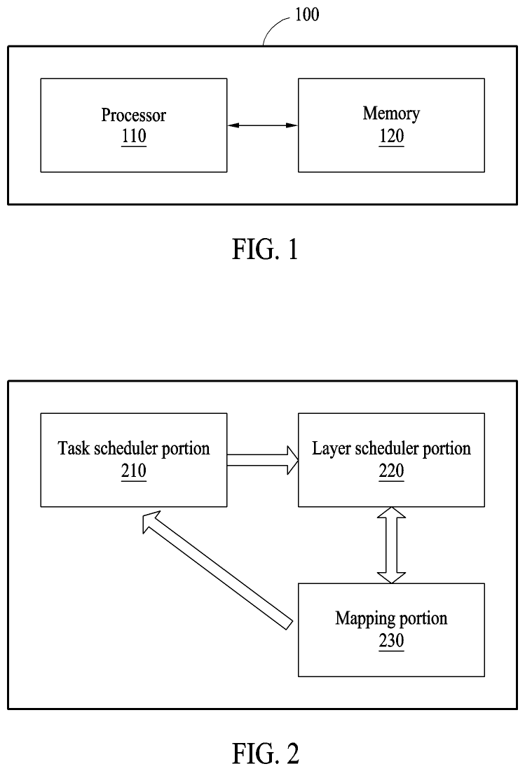

FIG. 1 illustrates an example of an electronic device for scheduling training of a transformer model according to one or more embodiments.

Referring to FIG. 1, in a non-limiting example, an electronic device 100 may be a device for scheduling training of a transformer model. The electronic device 100 may be one of various types of electronic devices. The electronic device 100 may be, for example, a portable communication device (e.g., a smartphone), a computer device, a portable multimedia device, a portable medical device, a camera, a wearable device, a home appliance device, or a server. However, the electronic device 100 is not limited to the foregoing examples.

As noted above, the electronic device 100 may include a processor 110 and a memory 120. The processor 110 may execute, for example, instructions stored in the memory 120, to control at least one other component (e.g., a hardware or software component) of the electronic device 100 connected to the processor 110 and may perform a variety of data processing or operations.

As at least part of data processing or operations, the processor 110 may store instructions or data in the memory 120, process the instructions or data stored in the memory 120, and store result data in the memory 120. The processor 110 may include, as non-limiting examples, a main processor (e.g., a central processing unit (CPU) or an application processor (AP)) or an auxiliary processor (e.g., a GPU, a neural processing unit (NPU), an image signal processor (ISP), a sensor hub processor, or a communication processor (CP)) that is operable independently of, or in conjunction with the main processor.

The processor 110 may control an overall operation of the electronic device 100 and perform one or more of operations described herein.

In an example, in response to the instructions being executed by the processor 110, the processor 110 may be configured to receive batches of data to be used to train the transformer model and perform an operation of dividing the received batches into a plurality of micro-batches, to perform an operation of determining layer pairs of the plurality of micro-batches, to perform an operation of determining a processing order of the layer pairs, to perform an operation of determining resource information to be allocated to the layer pairs, and to perform an operation of allocating resources to the layer pairs based on the resource information. In an example, the batches may include input data.

The processor 110 may perform an operation of dividing the batches into a plurality of micro-batches having no dependency on each other.

The processor 110 may perform an operation of calculating an idle time in response to resources being allocated to the layer pairs.

The processor 110 may perform an operation of calculating the idle time until the calculated idle time is minimized.

The processor 110 may perform an operation of provisioning some or all layers of the plurality of micro-batches into the layer pairs based on the idle time.

The processor 110 may perform an operation of calculating a total operation execution time in response to resources being allocated to some or all of the layer pairs.

The processor 110 may perform an operation of calculating the total operation execution time until the calculated total operation execution time is minimized.

The processor 110 may perform an operation of placing some, most, or all of the layers of the plurality of micro-batches as the layer pairs based on the total operation execution time.

The processor 110 may classify layers included in the layer pairs into predefined types of layers according to an operation per byte ratio of an operation performed on each of the layers and perform an operation of determining, or assigning, resource information to be allocated to the layer pairs including layers, each of the layers belonging to a separate type. In a non-limiting example, the allocation may be performed in a predefined manner.

The predefined types of layers may include a first layer type that may be layers in which the operation per byte ratio of the operation performed on these layers is greater than or equal to a predetermined first reference operation per byte ratio. The predefined types of layers may include a second layer type that may be layers in which the operation per byte ratio of the operation performed on these layers is less than the predetermined first reference operation per byte ratio while being greater than or equal to a predetermined second reference operation per byte ratio. The predefined types of layers may include a third layer type that may be layers in which the operation per byte ratio of the operation performed on these layers is less than the predetermined second reference operation per byte ratio.

In one example, the allocation, or the predefined manner of determining the allocation of resource information, may include in a first instance, allocating the layers of a layer pair to a resource core in response to the layer pair having layers that belong to the first layer type and the second layer type, respectively. In another example, the allocation, or predetermined manner of allocating, may, in response to a layer pair having layers that belong to the first layer type and the third layer type, respectively, assign or allocate the layer belonging to the first layer type to the resource core and the layer belonging to the third layer type being allocated to a unified vector unit (VU). In an example, the allocating may be an assigning of resource information based on the layers that are present in the layer pair.

The first layer type may include a layer on which a general matrix multiply operation is performed, the second layer type may include a layer on which a batched general matrix multiply is performed, and the third layer type may include a layer on which a normalization operation is performed.

FIG. 2 illustrates an example of a concept of scheduling training of a transformer model according to one or more embodiments.

Referring to FIG. 2, an electronic device for scheduling training of a transformer model may include a task scheduler portion 210, a layer scheduler portion 220, and a mapping portion 230. These portions may be separate processor-including devices, or any combination of the respective operations of the task scheduler portion 210, the layer scheduler portion 220, and/or the mapping portion 230 may be performed by one or more processors represented by the electronic device. A transformer model training process may include different operations including a general matrix multiply operation (hundreds of operation per byte ratios), a batched general matrix multiply operation (tens of operation per byte ratios), a memory intensive operation, and a normalization operation. Accordingly, operations with various operation per byte ratios may be performed alternately in the training process. In a one example, in a tile-based accelerator environment, a core operation of a transformer may be a general matrix multiply operation, a batched general matrix multiply operation, and a normalization operation. In the tile-based accelerator environment, a simple operation such as scale, mask, and dropout may be processed in a pipeline in a VU in a core. However, the normalization operation (e.g., softmax and layer normalization) that requires data across multiple cores has a low operation per byte ratio and still requires off-chip memory access.

In an accelerator environment, operations for transformer model training may be sequentially processed, and underutilization of a memory bandwidth and computing resources may occur depending on an operation per byte ratio of each of the operations. Compute-intensive operations with high operation per byte ratios, such as FC, Query, Key, may be divided into matrix units (MUs) and processed. In this case, a compute unit in an MU may be highly utilized, but a memory bandwidth may be relatively underutilized. In another example, the normalization operation may be processed in a VU. In this case, a memory bandwidth may be highly utilized, but a compute unit in an MU may be underutilized. By utilizing gradient accumulation and sequence binning features for transformer training, which is a single large task, it may be possible to divide batches into a plurality of micro-batches with different operation features and no dependency.

In a non-limiting example, the task scheduler portion 210 may divide batches to be processed into smaller micro-batch units and process the batches and perform gradient accumulation. Gradient accumulation may be a technique for performing only a weight update in these micro-batch units. The task scheduler portion 210 may perform sequence binning. Sequence binning may be a technique for classifying the batches to be processed into bins according to sequence lengths and configuring the micro-batches in the bins. Thus, the task scheduler portion 210 may divide the batches into the plurality of micro-batches having no dependency on each other. The task scheduler portion 210 may divide the batches to be processed into micro-batch units and select batches with a greatest performance gain. The task scheduler portion 210 may determine a micro-batch pair from the batches to be processed as shown in Equation 1.

max(timeₛₑᵣᵢₐₗ[mbᵢ,mbⱼ]−timeₚₐᵣₐₗₗₑₗ[mbᵢ,mbⱼ]) Equation 1:

In Equation, 1, for example, mbᵢ and mbⱼ may denote micro-batches included in a micro-batch pair, timeₛₑᵣᵢₐₗ[mbᵢ, mbⱼ] denotes a time it takes for the micro-batch pair including mbᵢ and mbⱼ to be processed in serial, timeₚₐᵣₐₗₗₑₗ[mbᵢ, mbⱼ] denotes a time it takes for the micro-batch pair including mbᵢ and mbⱼ to be processed in parallel, and max denotes that a difference between the time it takes for the micro-batch pair to be processed in serial and the time it takes for the micro-batch pair to be processed in parallel is maximized. Accordingly, a micro-batch pair of mbⱼ and mbⱼ with a largest difference between a time it takes for any two micro-batches to be processed serially and a time it takes for them to be processed in parallel may be determined as shown in Equation 1. The task scheduler portion 210 may find a micro-batch to be executed next in remaining batches based on a same criterion and perform this process on all batches.

The layer scheduler portion 220 may determine an order in which layers of micro-batches are processed in hardware. For example, the layer scheduler portion 220 may operate with a greedy algorithm used to obtain an optimal solution and determine, or ascertain, which layer pairs may minimize an idle time of resources of an accelerator at every instant. The order in which the layers are processed may be referred to as the processing order. In a non-limiting example, the processing order of the layer pairs may be assembled based on the greedy algorithm.

The mapping portion 230 may determine resource information ((off-chip memory bandwidth, L2 memory, Pes (process elements)) mapping) to be allocated to selected layer pairs in the layer scheduler portion 220 and allocate resources to the layer pairs based on the determined resource information. The mapping portion 230 may partition hardware resources and allocate partitions to the selected layer pairs. The mapping portion 230 may calculate an idle time of resources for corresponding resource information and transmit the idle time back to the layer scheduler portion 220. The layer scheduler portion 220 may receive feedback on the idle time from the mapping portion 230 and repeat the entire process until all layers have resource information about an optimal layer pair.

The mapping portion 230 may calculate a total operation execution time and then transmit the total operation execution time back to the task scheduler portion 210. The task scheduler portion 210 may receive feedback on the total operation execution time from the mapping portion 230 and then repeat the entire process and obtain an optimal schedule.

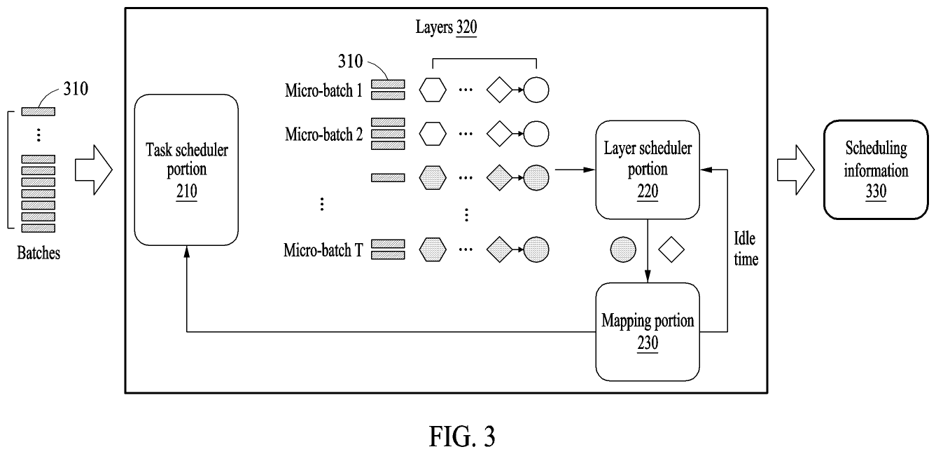

FIG. 3 illustrates an example of scheduling training of a transformer model according to one or more embodiments.

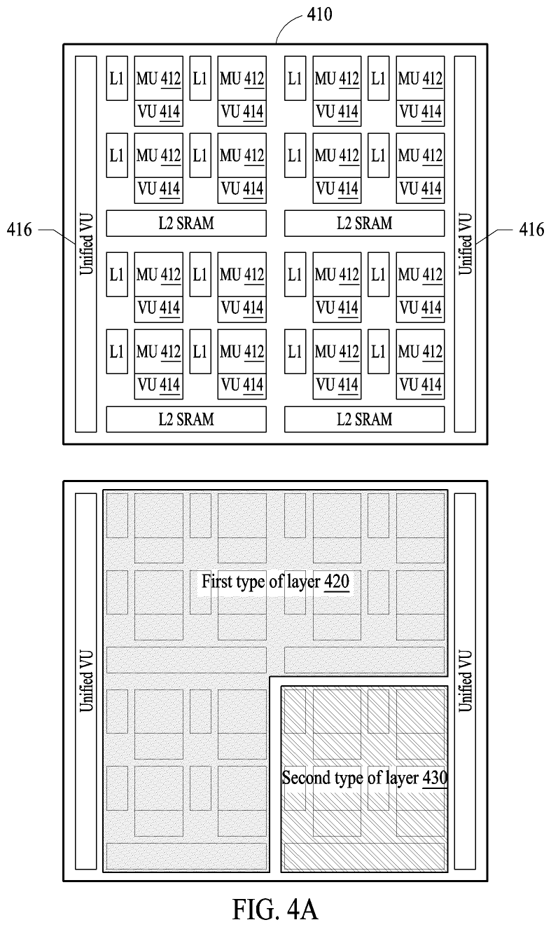

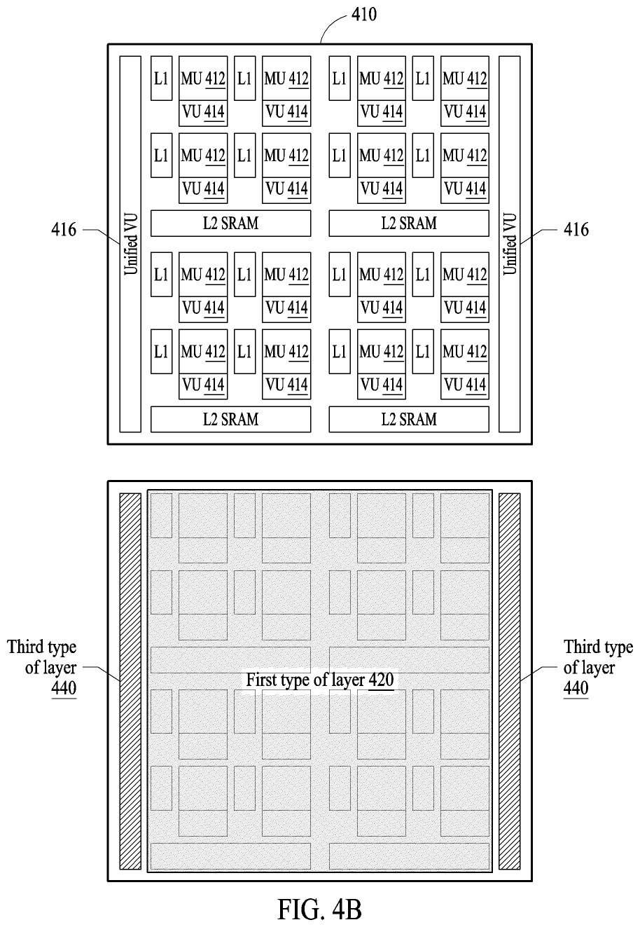

Referring to FIG. 3, in a method of scheduling training of a transformer model, the task scheduler 210 may, in one example, receive a plurality of batches 310. As described with reference to FIG. 2, the task scheduler portion 210 may perform, for example, gradient accumulation and sequence binning and divide the plurality of batches 310 into micro-batches 310 (micro-batches 1 to T) having no dependency on each other. Through the layer scheduler portion 220, layers 320 included in the micro-batches 310 may be divided into layer pairs, and then an order of processing the layer pairs in hardware may be determined. In a non-limiting example, the layers 320 may be analyzed by a processor of the electronic device to determine which layers may be paired to form layer pairs according to a desired, or optimal, solution. In another example, the layers 320 may be analyzed by a processor of the electronic device to determine a resource consumption indicator for one or more layers of the layers 320. For example, the layer scheduler portion 220 may operate with a greedy algorithm and be used to obtain a desired, or optimal, solution and create layer pairs which would minimize an idle time of resources of an accelerator at every instant. The mapping portion 230 may classify the layers 320 to train a transformer for efficient load balancing. For example, the mapping portion 230 may classify the layers into different types of layers. In one example, a first layer type may include an operation per byte ratio of an operation performed on each of the layers that is greater than or equal to a predetermined first reference operation per byte ratio. In another example, a second layer type may have an operation per byte ratio of the operation performed on each of the layers that is less than the predetermined first reference operation per byte ratio while being greater than or equal to a predetermined second reference operation per byte ratio. In another example, a third layer type may have an operation per byte ratio of the operation performed on each of the layers be less than the predetermined second reference operation per byte ratio. In a non-limiting example, the first reference operation per byte ratio may have a value of 100, and the second reference operation per byte ratio may have a value of 10. However, the first reference operation per byte ratio and the second operation per byte ratio are not limited thereto, and examples are also not limited thereto. The first layer type may include a layer on which a general matrix multiply operation is performed, the second layer type may include a layer on which a batched general matrix multiply operation is performed, and the third layer type may include a layer on which a normalization operation is performed. However, examples are not limited thereto. The mapping portion 230 may allocate resources depending on a type of each of the layers 320 included in the simultaneously processed layer pairs and provide feedback on an idle time to the layer scheduler portion 220 accordingly. The layer scheduler portion 220 may obtain a layer pair having a minimum idle time based on the idle time received from the mapping portion 230. In addition, the mapping portion 230 may allocate the resources depending on a type of each of the layers 320 included in the layer pairs and may allocate a total operation execution time to the task scheduler portion 210 accordingly. The task scheduler portion 210 may arrange a schedule of all tasks to be performed such that the total operation execution time is minimized based on the total operation execution time received from the mapping portion 230. A scheme of allocating resources in the mapping portion 230 is described below in detail with reference to FIGS. 4A and 4B.

FIGS. 4A and 4B illustrate examples of a resource allocation scheme according to one or more embodiments.

Referring to FIGS. 4A and 4B, a many-core system 410 may include a plurality of MUs 412, a plurality of VUs 414, and unified VUs 416.

Referring to FIG. 4A, an electronic device may allocate resources included in the many-core system 410 to layer pairs based on resource information. For example, when an obtained layer pair includes a layer corresponding to a first layer type and a layer corresponding to a second layer type, the electronic device may allocate these two operations by considering many-core system 410 hardware specifications (e.g., floating-point operations per second (FLOPS) and memory bandwidth), a number of operations to be performed on each of the two layers, and a required data size. The electronic device may allocate the layer belonging to the first layer type to a core 420 and allocate the layer belonging to the second layer type to a core 430, for example.

Referring to FIG. 4B, the electronic device may allocate the resources included in the many-core system 410 to the layer pairs based on the resource information. For example, when an obtained layer pair includes a layer corresponding to the first layer type and a layer corresponding to a third layer type, the electronic device may allocate these two operations by considering the many-core system 410 hardware specifications (e.g., FLOPS and memory bandwidth), the number of operations to be performed on each of the layers, and a required data size. The electronic device may allocate the layer belonging to the first layer type to the core 420 and allocate the layer belonging to the third layer type to a unified VU 440. The electronic device may increase resource utilization of computing and an off-chip memory bandwidth and reduce an idle time of resources by simultaneously allocating operations classified into three types to hardware. However, examples are not limited to particular forms shown in the drawings.

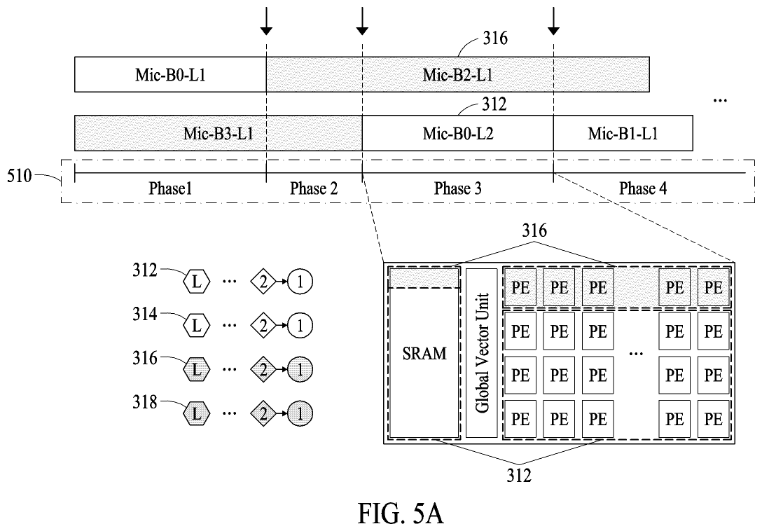

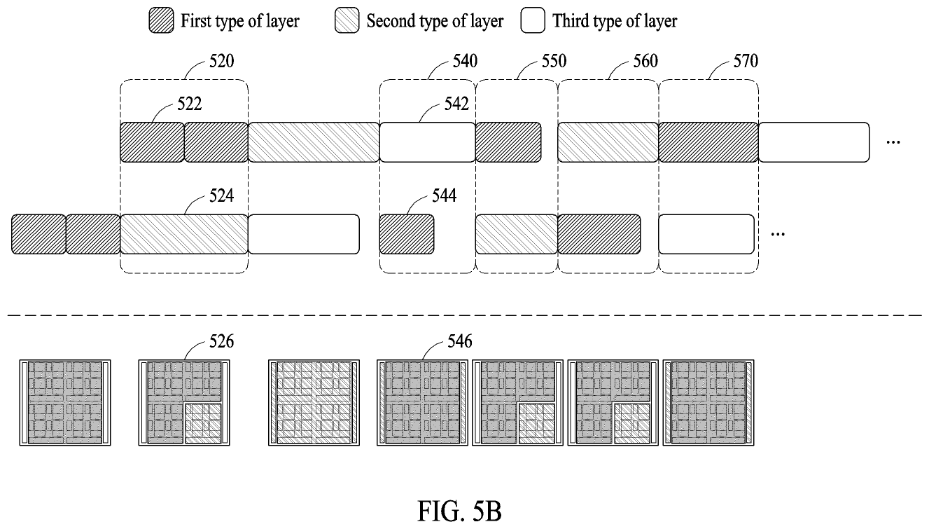

FIGS. 5A and 5B illustrate examples of a resource allocation scheme according to an operation per byte ratio according to one or more embodiments.

Referring to FIG. 5A, an electronic device may select a layer pair having a minimum idle time of resources during an operation from among layers 312, 314, 316, and 318 to form layers according to operation phases 510 (e.g., phases 1 to 4) over time. For example, in phase 3, the electronic device may select a micro-layer 316 and a micro-layer 312 to form the layer pair having the minimum idle time during an operation and may arrange these layers in each of resources in a way that is described in the examples of FIGS. 4A and 4B.

Referring to FIG. 5B, when a layer pair in an operation phase 520 includes a layer 522 belonging to a first layer type and a layer 524 belonging to a second layer type, the electronic device may allocate the layer 522 and the layer 524 to form the layer pair in a way that is described in the example of FIG. 4A. For example, the electronic device may allocate the layer 522 and the layer 524 in a manner similar to arrangement 526 by allocating the layer 522 to a core and the layer 524 to another core. When a layer pair in an operation phase 540 includes a layer 542 belonging to a third layer type and a layer 544 belonging to the first type of layer, the electronic device may allocate the layer 542 and the layer 544 forming the layer pair in a manner similar to the illustrated arraignment 544 by allocating the layer 542 to a unified VU and the layer 544 to a core. When a layer pair in an operation phase 550 includes a layer belonging to the first layer type and a layer belonging to the second layer type, the electronic device may allocate the layers in a way that is like 526 as described above. The same applies to an operation phase 560 in which a layer pair includes a layer belonging to the first layer type and a layer belonging to the second layer type. When a layer pair in an operation phase 570 includes a layer belonging to the first layer type and a layer belonging to the third layer type, the electronic device may allocate each of the layers forming the layer pair in a way that is like 546. However, a scheme of allocating resources according to an operation per byte ratio is not limited to the above-described particular examples.

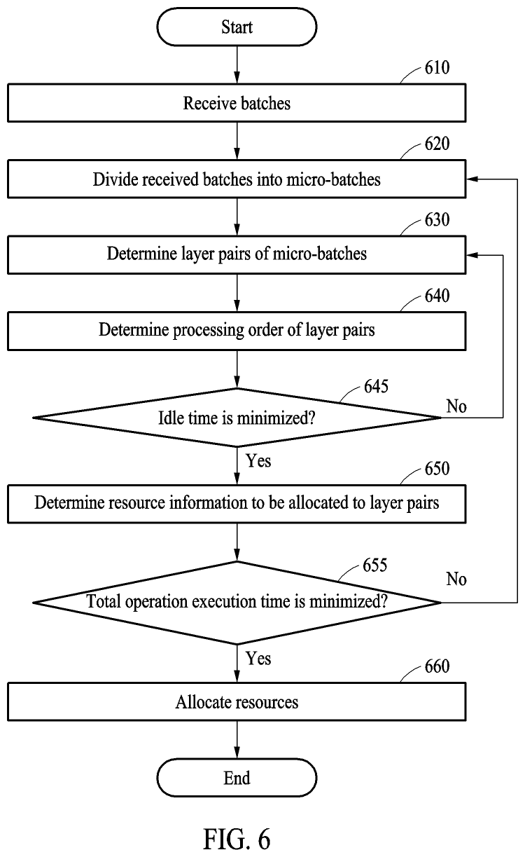

FIG. 6 illustrates an example of a control method of an electronic device according to one or more embodiments.

Referring to FIG. 6, in operation 610, an electronic device may receive batches. In operation 610, the electronic device may receive batches to be processed to train a transformer model.

In operation 620, the electronic device may divide the received batches into micro-batches. In operation 620, the electronic device may divide the batches into a plurality of micro-batches having no dependency on each other by applying at least one technique of gradient accumulation and sequence binning.

In operation 630, the electronic device may determine layer pairs of the micro-batches. In operation 630, the electronic device may determine micro-batches that satisfy the Equation 1, discussed above, as a pair among the plurality of micro-batches. In a non-limiting example, the electronic device may be analyzed to determine which layers form layer pairs according to a desired, or optimal, solution.

In operation 640, the electronic device may determine a processing order of the layer pairs. In operation 640, the electronic device may determine layer pairs that minimize an idle time of resources of an accelerator at every instant.

In operation 645, the electronic device may determine whether resource information about the determined layer pairs of the micro-batches minimizes the idle time. When the resource information about the determined layer pairs of the micro-batches does not minimize the idle time in operation 645, the electronic device may return to operation 630 and repeat the subsequent operations including operation 640 until the idle time is minimized.

In operation 650, the electronic device may determine resource information to be allocated to the layer pairs. The electronic device may determine the resource information such that resources are allocated to the layer pairs that minimize the idle time.

In operation 655, the electronic device may determine whether the allocated resource information minimizes a total operation execution time. When the allocated resource information does not minimize the total operation execution time in operation 655, the electronic device may return to operation 630 and repeat the subsequent operations including operation 650 until the total operation execution time is minimized.

In operation 660, the electronic device may allocate resources to the layer pairs based on the determined resource information. The electronic device may classify layers into different types of layers, including a first layer type that include layers in which an operation per byte ratio of an operation performed on these layers is greater than or equal to a predetermined first reference operation per byte ratio. In an example, a second layer type may include layers where an operation per byte ratio of an operation performed on these layers is less than the predetermined first reference operation per byte ratio while being greater than or equal to a predetermined second reference operation per byte ratio. In an example, a third layer type may include layers where an operation per byte ratio of an operation performed on these layers is less than the predetermined second reference operation per byte ratio. The electronic device may then allocate resources to layer pairs accordingly.

The electronic devices, processors, memories, electronic device 100, processor 110, memory 120, task scheduler portion 210, layer scheduler portion 220, and mapping portion 230 described herein and disclosed herein described with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A device, comprising:
one or more processors configured to execute instructions; and
a plurality of memories storing the instructions, which when executed by the processors configure the processors to perform an operation for training a transformer model having a plurality of encoders and a plurality of decoders, by configuring the processors to:
identify batches of training data into a plurality of micro-batches;
select layer pairs for the plurality of micro-batches;
assemble a processing order of the layer pairs;
determine resource information to be allocated to the layer pairs; and
allocating resources to the layer pairs based on the determined resource information to be allocated to the layer pairs, dependent on the processing order of the layer pairs.

2. The device of claim 1, wherein the one or more processors are configured to divide the batches into a plurality of micro-batches having no dependency on each other.

3. The device of claim 1, wherein the one or more processors are configured to calculate an idle time in response to resources being allocated to the layer pairs.

4. The device of claim 3, wherein the one or more processors are configured to calculate the idle time until the calculated idle time is minimized for the layer pairs.

5. The device of claim 1, wherein, for the selecting, the one or more processors are configured to assign layers of the plurality of micro-batches as the layer pairs based on an idle time.

6. The device of claim 1, wherein the one or more processors are configured to calculate a total operation execution time in response to resources being allocated to the layer pairs.

7. The device of claim 6, wherein, for the selecting, the one or more processors are configured to minimize the total operation execution time, used in the identifying, until the calculated total operation execution time is minimized.

8. The device of claim 1, wherein, for the identifying, the one or more processors are configured to assign layers of the plurality of micro-batches as the layer pairs based on a total operation execution time.

9. The device of claim 1, wherein the one or more processors are further configured to determine the resource information through the processors being configured to:
respectively classify layers of each of the layer pairs into a corresponding layer type, among predefined layer types, according to an operation per byte ratio of an operation performed on each of the layers; and
determine resource information to be allocated to the layer types where each layer belongs to a separate type of layer.

10. The device of claim 9, wherein the predefined layer types comprise:
a first layer type including layers having a first operation per byte ratio of the operation performed on each of the layers that is greater than or equal to a predetermined first reference operation per byte ratio;
a second layer type including layers having a second operation per byte ratio of the operation performed on each of the layers that is less than the predetermined first reference operation per byte ratio and that is greater than or equal to a predetermined second reference operation per byte ratio; and
a third layer type including layers having a third operation per byte ratio of the operation performed on each of the layers that is less than the predetermined second reference operation per byte ratio.

11. The device of claim 9, wherein, for the determining of resource information, the one or more processors are configured to: allocate respective layers that form a respective layer pair to a resource core responsive to the respective layers belonging to a first layer type and a second layer type; and
allocate a first layer type of the respective layer pair to the resource core and a third layer type of the respective layer pair to a unified vector unit (VU) responsive to the respective layers belonging to the first layer type and the third layer type.

12. The device of claim 11, wherein the first layer type comprises a layer on which a general matrix multiply operation is performed,
wherein the second layer type comprises a layer on which a batched general matrix multiply operation is performed, and
wherein the third layer type comprises a layer on which a normalization operation is performed.

13. A processor-implemented method, the method comprising:
dividing batches of data into a plurality of micro-batches;
forming layer pairs from layers of the plurality of micro-batches;
generating an operation processing order of the layer pairs;
determining resource information to be allocated to the layer pairs; and
allocating resources to the layer pairs based on the resource information.

14. The method of claim 13, wherein the dividing of the batches into the plurality of micro-batches comprises dividing the batches into the plurality of micro-batches to minimize a total operation execution time.

15. The method of claim 13, wherein the forming of the layer pairs comprises assigning layers from the plurality of micro-batches into the layer pairs to minimize an idle time.

16. The method of claim 13, wherein the determining of the resource information to be allocated to the layer pairs comprises:
classifying the layers into predefined layer types according to an operation per byte ratio of each of the layers; and
determining resource information to be allocated to a respective layer pair comprising layers, of which each layer of the layers belongs to a separate type of the predefined layer types.

17. The method of claim 16, wherein the predefined layer types comprise:
a first layer type including layers having a first operation per byte ratio of the operation performed on each of the layers that is greater than or equal to a predetermined first reference operation per byte ratio;
a second layer type including layers having a second operation per byte ratio of the operation performed on each of the layers that is less than the predetermined first reference operation per byte ratio and that is greater than or equal to a predetermined second reference operation per byte ratio; and
a third layer type including layers having a third operation per byte of an operation performed on each layer that is less than the predetermined second reference operation per byte.

18. The method of claim 16, wherein the determining of the resource information comprises:
allocating respective layers that form a respective layer pair to a resource core responsive to the respective layers belonging to a first layer type and a second layer type; and
allocating a first layer type of the respective layer pair to the resource core and a third layer type of the respective layer pair to a unified vector unit (VU) responsive to the respective layers belonging to the first layer type and the third layer type.

19. The method of claim 17, wherein the first layer type comprises a layer on which a general matrix multiply operation is performed,
wherein the second layer type comprises a layer on which a batched general matrix multiply operation is performed, and
wherein the third layer type comprises a layer on which a normalization operation is performed.

20. The method of claim 13, further comprising performing training of a transformer or an inference operation of a trained transformer, using the allocated resources.

21. A non-transitory computer-readable storage medium storing instructions that, when executed by a processor, cause the processor to perform the method of claim 13.

22. A device, comprising:
a processor configured to execute instructions; and
a memory storing the instructions, wherein execution of the instructions configures the processor to be configured to:
identify a plurality of batches of input data into a plurality of micro-batches, wherein each micro-batch of the plurality of micro-batches has no dependency to other micro-batches of the plurality of micro-batches; and
assign a layer pair to each micro-batch of the plurality of micro-batch according to a resource consumption indicator, dependent on an analysis of layers of micro-batches for the consumption indicator, and a layer type of each layer of the layer pair.

23. The device of claim 22, wherein the processor is configured to allocate resources to the layer pair based on the resource information to be allocated to a plurality of layer pairs, dependent on a processing order of the layer pairs.
